(19) United States
(12) Patent Application Publication
(10) Pub. No.: US 2008/0196208 A1
(43) Pub. Date: Aug. 21, 2008

(54) Solid carbon dioxide as a fuel source

(76) Inventor: Dennis R. Klein, Albuquerque, NM (US)

Correspondence Address: DENNIS R. KLEIN, 10601 HATCH DR. NW, ALBUQUERQUE, NM, 87114, US

(21) Appl. No.: 11/708,205

(22) Filed: Feb. 20, 2007

(51) Int. Cl. B01D 8/00

(52) U.S. Cl. 23/294 R

(57) ABSTRACT

Embodiments of solid carbon dioxide fuel utilize the sublimating properties of solid carbon dioxide. When placed inside an expansion chamber, with water, the sublimating CO₂ creates pressure. This pressure then, when vented to the drive mechanism of an engine, creates mechanical energy.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

This invention relates to the utilization of solid carbon dioxide as a fuel source by using the sublimating properties of solid carbon dioxide to specifically create pressure when contained. This pressure can then be converted to mechanical energy.

2. Prior Art

Carbon dioxide is an atmospheric gas comprised of one carbon and two oxygen atoms. A very widely known chemical compound, it is often referred to by its formula CO₂. It is present in the earth's atmosphere at a low concentration and acts as a green house gas. In its solid state it is called dry ice. It is a major component of the carbon cycle.

Atmospheric carbon dioxide derives from multiple natural sources including volcanic out gassing, the combustion of organic matter, and the respiration process of living aerobic organisms. Manmade sources of carbon dioxide come mainly from the burning of various fossil fuels for power generation and transportation use. It is also produced by various micro organisms from fermentation and cellular respiration. Plants utilize carbon dioxide during photosynthesis, using both the carbon and oxygen to construct carbohydrates. In addition, plants also release oxygen to the atmosphere which is subsequently used for respiration by heterotrophic organisms, forming a cycle.

Dry ice is a generalized trademark for solid carbon dioxide. The term was made in 1925 by Prest Air Devices, founded in Long Island City, N.Y. The name refers to the fact that under normal atmospheric pressure solid carbon dioxide sublimates, meaning it changes directly into a gas without passing through a wet liquid phase. When dry ice changes from a solid to a gas, it absorbs heat and expands to over 800 times its original volume. 50 grams of dry ice, or about 32 cubic centimeters, can create about 180 pounds per square inch of pressure in a two liter container. This pressure will be reached gradually until the dry ice has fully sublimated.

Dry ice is produced by compressing carbon dioxide gas to a liquid form, removing the heat produced by compression and letting the liquid carbon dioxide expand quickly. This expansion and the high speed evaporation of carbon dioxide cools the remainder of the liquid down to the melting point. At that point, some of the CO₂ freezes into snow which is then compressed into pellets or blocks. The freezing point of carbon dioxide is −109.3 degrees Fahrenheit or −78.5 Celsius.

Most engines that require combustion in their operation burn various forms of fossil fuels. This produces carbon dioxide which is a green house gas and contributes to global warming. Being a major source of pollution is another drawback of the burning of fossil fuels. The utilization of petroleum products also increases our dependence on foreign oil.

Congress passed an energy bill in 2005 that mandated the doubling of alternative fuel use by 2012 to 7.5 billion gallons a year. President Bush, in his 2007 State of the Union speech sought a boost in alternative fuel use to 35 billion gallons a year.

Solid carbon dioxide fuel can play a role in the reduced reliance on foreign oil equation. A company called Universal Industrial Gases, Inc. supplied and commissioned a 250 ton per day liquid CO₂ plant in conjunction with the production of the corn-to-ethanol manufacturing process in Utica, Wis. The liquid CO₂ plant processes raw CO₂ feed gas produced as a by-product of the corn-to-ethanol manufacturing process. The plant captures the carbon dioxide instead of releasing it into the atmosphere, then liquefies and stores it. The liquid CO₂ would then be available for use in making dry ice, which then can be used as an alternate source of fuel.

### SUMMARY

In accordance with embodiments when solid carbon dioxide is placed into an expansion chamber with water, sublimation takes place. The sublimating CO₂ creates pressure within the chamber. This pressurized gas can then be converted to mechanical energy.

### DRAWINGS—FIGURES

None

### DRAWINGS—REFERENCE NUMBERS

None

### DETAILED DESCRIPTION—FIRST EMBODIMENT

One embodiment of the use of solid carbon dioxide as a fuel is in engines that require steam as a source of pressure to drive the engine. Steam engines and steam turbine engines utilize the expanding steam to create pressure. This pressure is then vented into the engine to create mechanical energy. The pressurized steam can be substituted by pressurized CO₂ gas created by the sublimating solid carbon dioxide fuel.

### OPERATION—FIRST EMBODIMENT

Water is added to the engine boiler which acts as the expansion chamber. Solid carbon dioxide is then added. The chamber is then sealed. As the solid carbon dioxide sublimates it builds pressure. The pressurized CO₂ gas is then vented in to the engine. The engine then converts the pressurized CO₂ gas into mechanical energy.

### DESCRIPTION—ADDITIONAL EMBODIMENT

The additional embodiment would include modifications to the expansion chamber to include a heating element to regulate the water temperature. A fuel control unit would also be incorporated to regulate fuel flow. These two modifications would be used in conjunction with each other to maintain an optimum sublimation rate and pressure range for continuous engine operation.

### OPERATION—ADDITIONAL EMBODIMENT

Water is added to the boiler of the engine which acts as the expansion chamber. The chamber is then sealed. Solid carbon dioxide is then added to the fuel control unit and begins feeding fuel into the chamber. As the pressure builds to the operating range of the engine, the pressure is vented to the engine and it begins to operate. The heating element becomes active and maintains a constant water temperature range. The fuel control feeds solid CO₂ fuel into the expansion chamber to maintain a specific pressure range for continuous engine operation.

### DESCRIPTION—ALTERNATE EMBODIMENT

An alternate embodiment would be in the use of solid carbon dioxide fuel in engines that do not utilize steam but operate on the principle of an expanding gas. The fuel tank would be replaced by an expansion chamber with a heating element and fuel control unit The engine would be modified with a gas control system that provides pressurized CO₂ gas to the engine's drive mechanism that converts the pressurized gas into mechanical energy.

### OPERATION—ALTERNATE EMBODIMENT

Water is added to the expansion chamber. The chamber is then sealed. Solid carbon dioxide is then added to the fuel control unit and the unit begins feeding fuel into the chamber. The heating element becomes active, maintaining a specific temperature range. As the pressure builds to the operating pressure, the pressurized CO₂ gas is vented to the gas control system. The gas control system then provides CO₂ gas to the engine's drive mechanism that converts the pressurized gas into mechanical energy.

### CONCLUSION, RAMIFICATIONS AND SCOPE

Accordingly the reader will see that solid carbon dioxide as a fuel source could be a viable alternative to petroleum based fuels, thus reducing our dependence on foreign oil. It has the advantage of utilizing CO₂ instead of creating it. It does not emit the other pollutants associated with the burning of fossil fuels. If the liquid CO₂ used to make solid carbon dioxide is captured as a by product, such as in the manufacture of ethanol, the benefit of both reduced reliance on foreign oil and reducing pollution can be realized.

Although the description above contains many specificities, it should not be construed as limiting the scope of the embodiment but merely providing illustrations of some of the presently preferred embodiments.

Thus the scope of the invention should be determined by the appended claims and their legal equivalents, and not by the examples given.

I claim:

1. Solid carbon dioxide can be used as a fuel source by utilizing the sublimating properties of solid carbon dioxide when contained, to create pressure. This pressure can then be converted to mechanical energy.
